(19) United States
(12) Patent Application Publication
(10) Pub. No.: US 2018/0014582 A1
(43) Pub. Date: Jan. 18, 2018

(54) ADVERTISING AND SAFETY VEST FOR SPORTSPEOPLE

(71) Applicants: Borja ORTIZ MARTIN, Sevilla (ES); Montserrat CARO GONZALEZ, Sevilla (ES)

(72) Inventors: Borja ORTIZ MARTIN, Sevilla (ES); Montserrat CARO GONZALEZ, Sevilla (ES)

(21) Appl. No.: 15/544,284

(22) PCT Filed: Apr. 15, 2015
(86) PCT No.: PCT/ES2015/070303

§ 371 Date: Jul. 18, 2017

(30) Foreign Application Priority Data
Feb. 9, 2015 (ES) U201530133

(51) Int. Cl. A41D 1/04; G09F 21/02; A41D 27/08

(52) U.S. Cl. CPC A41D 1/04; A41D 27/085; G09F 21/02

(57) ABSTRACT

The invention relates to an advertising and safety vest for sportspeople, which incorporates, in the sports garment, a panel consisting of luminous LED-type elements, which sits on the chest of the runner, is enveloped in an impermeable safety cover, and connected to a small and light controller. The invention also provides an application for smart phones, so that the promotor of the advertising campaigns, in relation to the sports garment, can design the campaigns, participation numbers, and maximum amount of participants, and the user can exercise safely and activate the economic remuneration for the advertisement on the basis of the signal sent by the GPS of the user's mobile when they are running, riding a bicycle or walking. The invention also relates to a smart phone for carrying out the automatic transmission of data, using the GPS.

### OBJECT OF THE INVENTION

This invention is a piece of clothing for runners, cyclists, etc., which, on its most visible side, has advertising that can be independently lit up when the user so chooses. On the one hand, this makes the athlete highly visible; and on the other, it provides commercial exposure for the brand.

This invention applies to the advertising sector; specifically, the manufacture of clothing and accessories for advertising purposes.

### BACKGROUND TO THE INVENTION

In terms of the state of the art, clothing fitted with LEDs mounted on printed circuit boards does exist. This type of clothing is designed to be safety clothing, such as safety vests to increase the visibility of road and construction workers.

There are also items of clothing and accessories that reflect light in the darkness by using fluorescent or phosphorescent paint. In order for such items to be reflective and shine (they don't emit light) they need absolute darkness.

Utility Model no. 1075, called “Item of clothing with decorative lighting”, proposed using LED lights with ornamental or aesthetic purposes.

Thus, the state of the art includes LED shirts with a light panel made with luminous dust, an ITO film, and a printed layer. They are used, for example, to display pictures with lights and equalisers that are sensitive to sound and make the lights move in time with music.

There are also LED vests used by athletes to make them more visible to vehicles on the road and thereby reducing the risk of an accident.

Based on the background described, the “advertising and safety vest for athletes” contributes to the state of the art by introducing an item of clothing fitted with LEDs, which retains the function of increasing visibility on roads, and adds a function whereby the runner can make money from the advertising on his or her vest, proportionally to the duration of their run, through a specific smartphone application.

### EXPLANATION OF THE INVENTION

The “advertising and safety vest for athletes” is a sports garment made from polyester, which is fitted with LED-type luminous elements. When the athlete is wearing the vest, the panel will be on the runner's chest, protected by a waterproof cover, connected with a special connector and short cable to a small and light controller with two 3V button cell batteries designed to be used outdoors. Alternatively, the controller could use a rechargeable battery.

The cable that connects the LED panel to the controller has a plastic cover that protects it from the rain and makes it safe for the user. The controller has a switch to turn it on.

The set is complemented with a smartphone application (app), where the advertiser can design the type of advertising campaign, the rules for taking part, the maximum number of participants, incentive, etc.; and the user can sign up safely and earn money for the advertising based on their phone's GPS signal when they're running, cycling, or walking.

If the garment is part of an advertising campaign based on the advertising shown on the LED panels of users who have signed up for the campaign, bought the vest, and downloaded the app, said users can earn money for the distance they cover based on the GPS data sent from their phone.

In addition, once the vest is on and active, it enhances the runner's safety by improving their visibility when the LED panel is on, which can also be set to blinking mode to protect against vehicles or other threats on roads with low visibility.

### DESCRIPTION OF THE DRAWINGS

In order to complement the current description and to facilitate a better understanding of the characteristics of the invention, as well as display the preferred embodiment of the invention, a set of drawings is attached, which are an integral part of this description, for the purposes of illustration only, showing the following:

FIG. 1: Main view of the “advertising and safety vest for athletes” on a person who is running.

FIG. 2: View of the elements that make up the LED panel on the sports garment.

The following constituent elements can be highlighted in the aforementioned figures:
1. LED light panel.
2. Connector
3. Cables
4. Controller

### EXAMPLE OF A PREFERRED EMBODIMENT WITH FIGURES

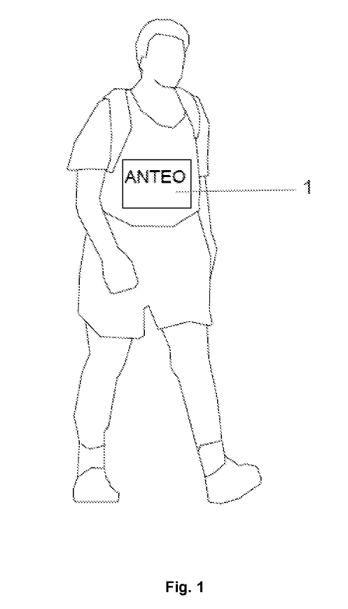

FIG. 1 shows a preferred embodiment of the “advertising and safety vests for athletes” in advertising campaigns: a runner wearing the sports garment with the LED luminous panel with the advertising content (1) displayed on the user's chest.

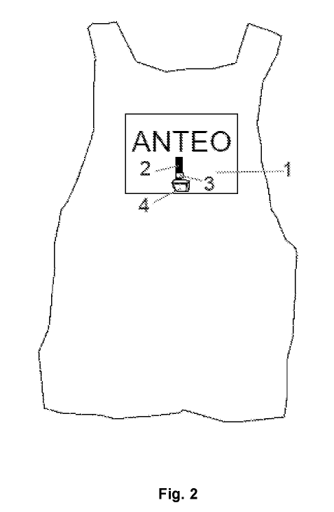

FIG. 2 shows a close-up of the luminous advertising panel with the flex connector (2), cables (3), and the battery controller (4).

Based on the described elements, the invention allows runners to become advertising elements by wearing a sports garment that incorporates advertising displayed on a luminous panel which can be set to a high intensity or blinking mode. Therefore, athletes who sign up for an advertising campaign need to have a smartphone with an app that monitors the distance they cover. By turning on the sports garment and exercising, they will receive some financial reward that will encourage them to continue with their training, and advertisers will be able to reach spaces that can only be reached in this manner.

This descriptive report is considered sufficient so that any expert in the matter might understand the scope of the invention and the advantages which could be derived from its use.

The design of the garment, the material used, the location of the advertising, LED or any other type of lighting, the use of batteries or rechargeable batteries, or the technology in general, may be modified as long as it does not alter the essence of the invention.

The terms which have been used in this report should be understood broadly and non-exhaustively.

1. Advertising and safety vest for athletes to use in advertising campaigns, achieved by bringing together the following elements:
A. A polyester sports garment.
B. An advertising panel built into the sports garment, made up of LED or similar elements protected by a waterproof cover, which is connected with a connector and short cable, also protected by a cover, with a small and light controller with two 3V button cell batteries and an on-and-off switch.
C. An opaque plastic cover that protects the cable from the rain.
D. A controller on-and-off switch. Alternatively, the vest could be fitted with a rechargeable battery.
E. A smartphone.
F. A multi-platform application that uses the phone's GPS signal to determine its location, and a data network to exchange data between the server and the mobile device.

2. Procedure for using the advertising and safety vest for athletes described in claim 1, made up of the following steps:
A. Using a smartphone, the user of the vest may download a mobile application created by the advertiser and sign up for the campaign. The app will automatically send data about the use of the vest (distance covered) when worn by the user, using the phone's GPS signal.
B. Through the app, the smartphone will use the GPS signal to send data about the user's location to the data server, as well as information about the distance covered through a 3G/4G or WiFi network.
C. Once the wearer of the vest has signed up for the advertising campaign, the advertiser will financially reward the wearer of the vest, based on the signal and data (distance covered) sent by the phone's GPS signal while the user is running, cycling, or walking.
